(19) United States
(12) Patent Application Publication
(10) Pub. No.: US 2025/0342732 A1
(43) Pub. Date: Nov. 6, 2025

(54) WHEEL CONDITION DETERMINATION DEVICE, WHEEL CONDITION DETERMINATION METHOD, AND WHEEL CONDITION DETERMINATION PROGRAM

(71) Applicant: Sumitomo Rubber Industries, Ltd., Kobe-shi (JP)

(72) Inventor: Kazuma TOKUDA, Kobe-shi (JP)

(73) Assignee: Sumitomo Rubber Industries, Ltd., Kobe-shi (JP)

(21) Appl. No.: 19/082,201

(22) Filed: Mar. 18, 2025

(30) Foreign Application Priority Data
May 2, 2024 (JP) 2024-074958

(51) Int. Cl. G07C 5/04

(52) U.S. Cl. CPC G07C 5/04

(57) ABSTRACT

A wheel condition determination device can include an acceleration obtaining unit, a variation calculation unit, an index calculation unit, and a determination unit. The acceleration obtaining unit can sequentially obtain accelerations in an axle direction of each of wheels attached to both ends of an axle of a vehicle. The variation calculation unit can calculate, based on the sequentially obtained accelerations, variations in a time direction among the accelerations of each of the wheels. The index calculation unit can calculate an index for comparing the variations of the wheels. The determination unit can determine whether or not fixing mechanisms for fixing the wheels to the axle are loose, based on the index.

### CROSS-REFERENCE TO RELATED APPLICATION

This application claims the benefit of foreign priority to Japanese Patent Applications No. JP 2024-074958, filed May 2, 2024, which is hereby incorporated by reference in its entirety.

### BACKGROUND

### Field

The present disclosure relates to a technique for determining conditions of a wheel.

International Publication WO2023/145195 describes a wheel condition determination device that determines whether or not there is a sign that a wheel is about to come off a vehicle. This wheel condition determination device sequentially obtains axle-direction accelerations of a wheel in the axle direction, and determines that there is a sign that the wheel is about to come off if an obtained axle-direction acceleration(s) is greater than a predetermined determination threshold. In addition, in order to prevent erroneous determination of a wheel condition, the wheel condition determination device determines a travel condition of the vehicle, and ends the process of determining the wheel condition when determining that the vehicle is traveling on a bad road, for example.

According to International Publication WO2023/145195, the determination as to whether or not a vehicle is traveling on a bad road is executed based on an image captured by an imaging unit provided on the vehicle shooting an area in front of the vehicle. However, there are various types of bad roads that may affect the determination of a wheel condition, and therefore, it is considered that it is difficult to appropriately determine whether or not a vehicle is traveling on a bad road, based on images. In addition, such image-based determination is more difficult at nighttime. Under these circumstances, it is considered that the determination of a wheel condition disclosed in International Publication WO2023/145195 is affected by the road surface in no small degree.

### SUMMARY

A wheel condition determination device according to a first aspect of the present disclosure can include an acceleration obtaining unit, a variation calculation unit, an index calculation unit, and a determination unit. The acceleration obtaining unit can sequentially obtain accelerations in an axle direction of each of wheels attached to both ends of an axle of a vehicle. The variation calculation unit can calculate, based on the sequentially obtained accelerations, variations in a time direction among the accelerations of each of the wheels. The index calculation unit can calculate an index for comparing the variations of the wheels. The determination unit can determine whether or not fixing mechanisms for fixing the wheels to the axle are loose, based on the index.

A wheel condition determination device according to a second aspect of the present disclosure can be the wheel condition determination device according to the first aspect in which the index calculation unit can calculate an index for comparing the variations of the wheels after the variations are subjected to a smoothing process for each of the wheels.

A wheel condition determination device according to a third aspect of the present disclosure can be the wheel condition determination device according to the first or the second aspect, further including a warning generation unit configured to generate and output a warning when the determination unit determines that the fixing mechanism is loose.

A wheel condition determination method according to a fourth aspect of the present disclosure a wheel condition determination method that is executed by one or more computers, and can include:

(1) sequentially obtaining accelerations in an axle direction of each of wheels attached to both ends of an axle of a vehicle;

(2) calculating, based on the sequentially obtained accelerations, variations in a time direction among the accelerations of each of the wheels;

(3) calculating an index for comparing the variations of the wheels; and

(4) determining whether or not fixing mechanisms for fixing the wheels to the axle are loose, based on the index.

A wheel condition determination program according to a fifth aspect of the present disclosure can be a wheel condition determination program that causes one or more computers to:

(1) sequentially obtain accelerations in an axle direction of each of wheels attached to both ends of an axle of a vehicle;

(2) calculate, based on the sequentially obtained accelerations, variations in a time direction among the accelerations of each of the wheels;

(3) calculate an index for comparing the variations of the wheels; and

(4) determine whether or not fixing mechanisms for fixing the wheels to the axle are loose, based on the index.

### BRIEF DESCRIPTION OF THE DRAWINGS

FIG. 1 is a schematic diagram showing a situation in which a wheel condition determination device according to one or more embodiments is mounted on a vehicle;

FIG. 2 is a block diagram showing the electrical configuration of the wheel condition determination device according to one or more embodiments of the present disclosure;

FIG. 3 is a flowchart showing the process of a wheel condition determination method according to one or more embodiments of the present disclosure;

FIG. 4 is a diagram illustrating degrees of variations in acceleration according to one or more embodiments of the present disclosure; and

FIG. 5 is a diagram for describing the principle of the wheel condition determination method according to one or more embodiments of the present disclosure.

### DETAILED DESCRIPTION

It may be an object of one or more embodiments of the present disclosure, among one or more objects, to provide a technique capable of appropriately determining a wheel condition by cancelling the influence of a road surface on which a vehicle is traveling.

According to one or more embodiments of the present disclosure, the influence of a road surface on which a vehicle is traveling can be cancelled, so that it can be appropriately determined whether or not a fixing mechanism for fixing a wheel to an axle is loose, as a wheel condition.

A wheel condition determination device, a wheel condition determination method, and a wheel condition determination program according to one or more embodiments of the present disclosure will be described below with reference to the accompanying drawings.

### <1. Overall Configuration>

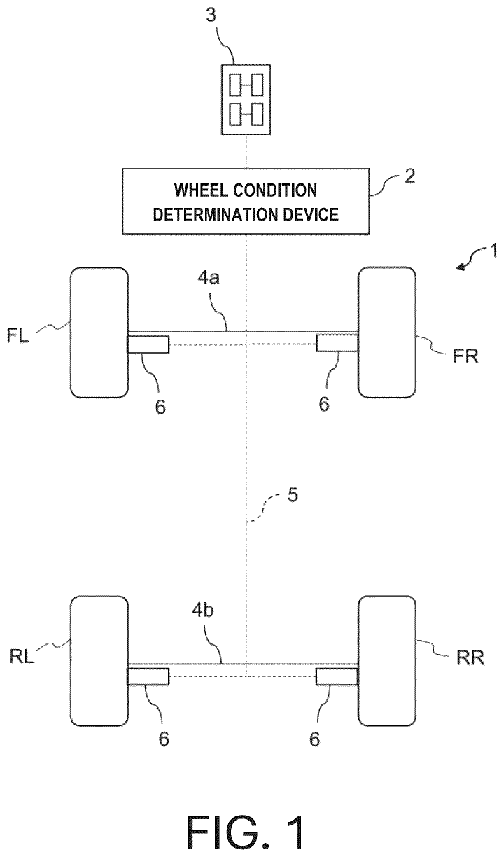

FIG. 1 is a schematic diagram showing a situation in which a wheel condition determination device 2 (also hereinafter simply referred to as “determination device 2”) according to one or more embodiments is mounted on a vehicle 1. The determination device 2 cam be configured as a control unit of the vehicle 1, for example. The vehicle 1 according to this embodiment(s) can include a front axle 4a and a rear axle 4b. A left front wheel FL and a right front wheel FR, and a left rear wheel RL and a right rear wheel RR, are fixed to both ends of the respective axles through fixing mechanisms. The term fixing mechanism may be referred to herein as a mechanical fixer or faster. The wheels FL, FR, RL, and RR each can include a wheel disk and a tire mounted on the wheel disk. According to one or more embodiments, fixing mechanisms that fix the respective wheels FL, FR, RL, and RR to the axles each can include a hub bolt and a wheel nut fastened to the hub bolt, for example, though embodiments of the present disclosure are not so limited to this specific example. If the wheel nut comes loose from the hub bolt, the wheel may begin to wobble and most likely will eventually come off the axle. The determination device 2 can determine whether or not the wheel nut is loose, as a wheel condition, and can warn the driver of the vehicle 1 when determining that the wheel nut is loose, thereby preventing the wheel from coming off.

An acceleration sensor 6 that can detect an acceleration in the axle direction or the vehicle width direction can be attached to each of the wheels FL, FR, RL, and RR. The acceleration sensors 6 can detect the accelerations in the axle direction of the wheels FL, FR, RL, and RR, respectively. The acceleration sensors 6 according to one or more embodiments can each be a three-axis acceleration sensor, for instance, that may be integrally configured with an air pressure sensor attached to the air valve of a respective wheel. The acceleration sensors 6 can be connected to the determination device 2 through a communication line 5, and can sequentially transmit detected accelerations of the respective wheels FL, FR, RL, and RR to the determination device 2.

The vehicle 1 may further include a warning display device 3. The warning display device 3 can display a warning that the wheel nut is loose, and can be embodied in any form, such as a liquid crystal display element, liquid crystal monitor, plasma display, organic EL display, or the like. The position where the warning display device 3 is attached can be appropriately selected, and can be, according to one or more embodiments, preferably a position where the warning display device 3 can be easily viewed by the driver, such as on an instrument panel. In the case where the determination device 2 is connected to an automotive navigation system, a monitor for automotive navigation may be used as the warning display device 3. A warning displayed on the warning display device 3 may be an icon, a graphic, or text information, or combination thereof, as but some examples.

### <2. Configuration of Determination Device>

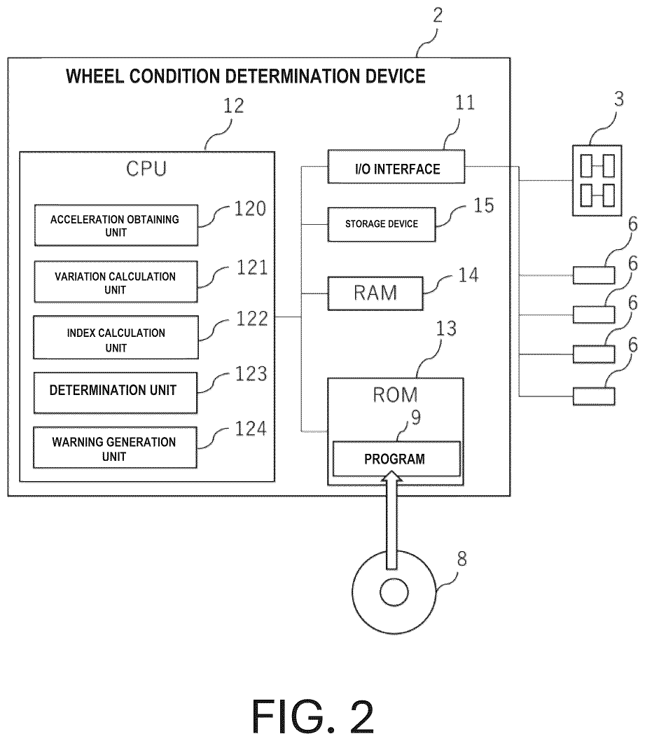

FIG. 2 is a block diagram showing the electrical configuration of the determination device 2 according to one or more embodiments of the present disclosure. The determination device 2 can be configured as a control unit computer of the vehicle 1 in a hardware sense, and includes an I/O interface 11, a central processing unit (CPU) 12, a read only memory (ROM) 13, a random access memory (RAM) 14, and a storage device 15. The I/O interface 11 can be a communication device for communicating with external devices such as the acceleration sensors 6 and the warning display device 3. The ROM 13 stores a program 9 for controlling the operation of each part of the vehicle 1. The program 9 may be loaded from a storage medium 8 such as a CD-ROM or USB memory into the ROM 13. The CPU 12 reads out the program 9 from the ROM 13, and executes the program 9 to virtually operate as an acceleration obtaining unit 120, a variation calculation unit 121, an index calculation unit 122, a determination unit 123, and a warning generation unit 124. The operations of the units 120 to 124 will be described later. It should be noted that the program 9 may be stored in the storage device 15 instead of the ROM 13. The RAM 14 and the storage device 15 may be used in calculation performed by the CPU 12 as appropriate. Each “unit” as described herein may be implemented fully in particularly in or using circuitry. The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor. Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory (ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

### <3. Wheel Condition Determination Method>

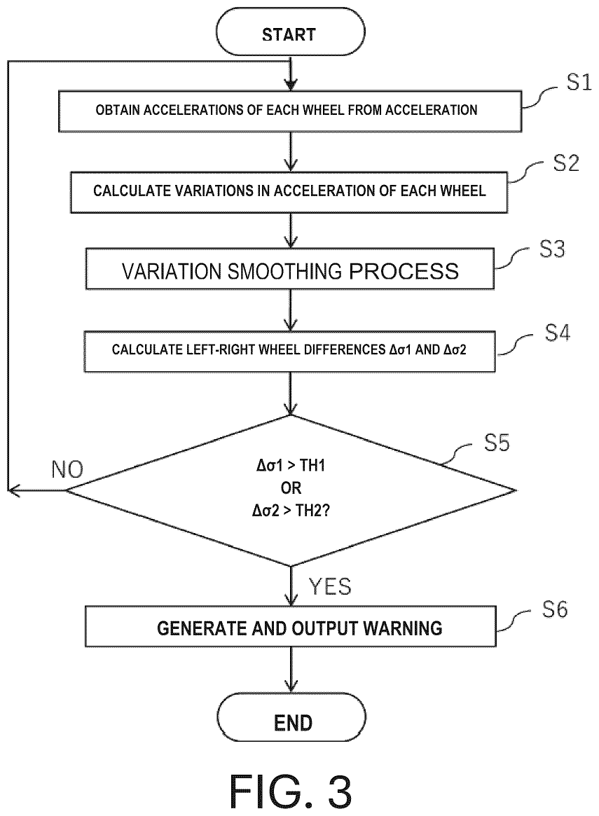

A determination process for determining whether or not one or more fixing mechanisms for fixing the wheels FL and FR to the front axle 4a are loose, and whether or not one or more fixing mechanisms for fixing the wheels RL and RR to the rear axle 4b are loose (wheel condition determination method) will be described below with reference to FIG. 3. The determination process, such as shown in FIG. 3, can be repeatedly executed at predetermined timings (e.g., once every 10 minutes) while the electrical system of the vehicle 1 is on, for example. The determination process according to one or more embodiments can determine whether or not one or more fixing mechanisms are loose for the front axle 4a and the rear axle 4b.

In step S1, the acceleration obtaining unit 120 can sequentially obtain accelerations α in the axle direction of each of the wheels FL, FR, RL, and RR from the respective corresponding acceleration sensors 6. The acceleration obtaining unit 120 can temporarily store, in the RAM 14, or can store, in the storage device 15, the accelerations α in time order in which the accelerations α have been obtained, in association with the wheels. Optionally, if the number of pieces of data of the accelerations a stored in step S1 is greater than or equal to a predetermined value, step S2 may be executed.

In step S2, the variation calculation unit 121 can calculate a variation in the time direction among the obtained time series of accelerations α of each wheel. Specifically, the variation calculation unit 121 can extract N pieces of data in a time window having a predetermined length between t1 and t2, from the time series of acceleration data of each wheel. The length of the time window may, for example, be 3 seconds. The standard deviation σ of the extracted N pieces of data may be calculated as a variation in the time direction among the accelerations α, for instance, according to an expression below. In the expression, “αₜ” can represent an acceleration α at time t between t1 and t2, and “αₐᵥₑ” can represent the average value of the N pieces of data of the accelerations α.

$$σ = \sqrt{\frac{1}{N} {\sum }_{t = t 1}^{t 2} ( {α}_{t} - {α}_{ave} )} \qquad [ Math . 1 ]$$

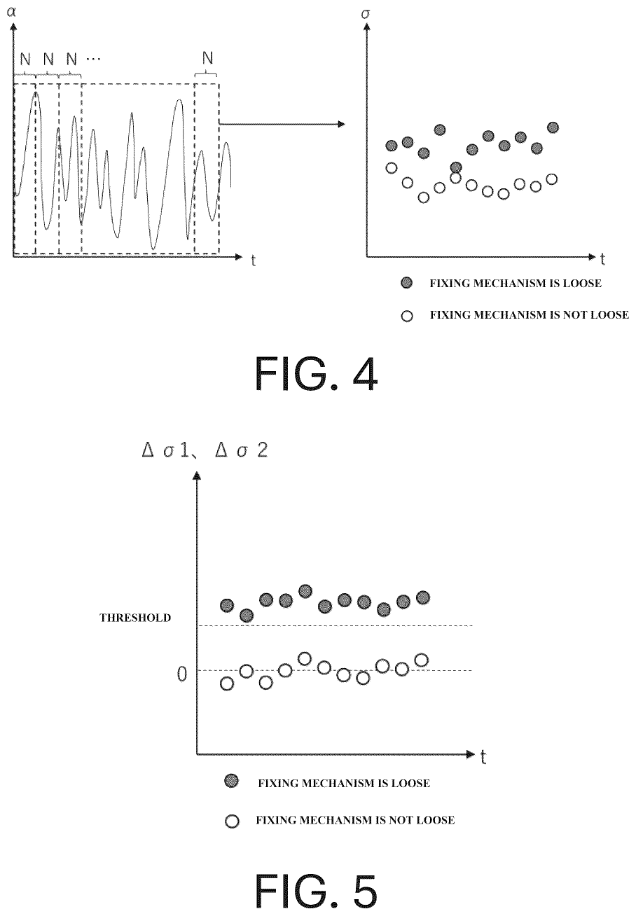

If a fixing mechanism is loose (e.g., a wheel nut is loose), vibrations (e.g., great) may be likely to occur in the axle direction. As a result, as shown in FIG. 4, the absolute values of obtained accelerations α may tend to be greater than in the normal state, and a variation in the time direction there among may also tend to be greater. The acceleration α may also vary (e.g., greatly) when the vehicle 1 is cornering or traveling on a bad road. In step S2 according to one or more embodiments, a plurality of time-series standard deviations o can be calculated for each wheel. If the number of calculated standard deviations σ reaches a predetermined value (e.g., corresponding to the number of as for 30 seconds), the next step S3 may be executed.

In step S3, the index calculation unit 122 can execute a process of smoothing the time series of the standard deviations σ calculated for each wheel. Specifically, the index calculation unit 122 can calculate the moving average of the time series of standard deviations σ for each wheel.

In step S4, the index calculation unit 122 can calculate an index for comparing variations in the accelerations α of the wheels on the same axle. More specifically, the index calculation unit 122 can calculate, as the index, left-right wheel differences Δσ1 and Δσ2 (at the same time) of the moving averages of the standard deviations σ calculated in step S3. In this embodiment, the left-right wheel difference Δσ1 can be the absolute value of the difference between the moving average of the standard deviations σ calculated for the wheel FL, and the moving average of the standard deviations σ calculated for the wheel FR. The left-right wheel difference Δσ2 can be the absolute value of the difference between the moving average of the standard deviations σ calculated for the wheel RL, and the moving average of the standard deviations σ calculated for the wheel RR. Vibrations received by wheels from the road surface may be substantially synchronous at both ends of the axle. Therefore, by comparing variations in the accelerations α in the same time section of the wheels attached to both ends of the axle, the influences of the road surface on the accelerations a can be cancelled out, for instance, so that the influence of the loose fixing mechanism can be reflected (e.g., predominantly) on the left-right wheel differences Δσ1 and Δσ2.

Specifically, as shown in FIG. 5, if neither of the fixing mechanisms for the left front wheel FL and the right front wheel FR is loose, the left-right wheel difference Δσ1 may be relatively close to zero, and if neither of the fixing mechanisms for the left rear wheel RL and the right rear wheel RR is loose, the left-right wheel difference Δσ2 may be close to zero. On the other hand, if the fixing mechanism for the left front wheel FL or the right front wheel FR is loose, the left-right wheel difference Δσ1 may be greater than zero (e.g., significantly), and if the fixing mechanism for the left rear wheel RL or the right rear wheel RR is loose, the left-right wheel difference Δσ2 may be greater (e.g., significantly) than zero.

In step S5, the determination unit 123 can determine whether or not any of the fixing mechanisms is loose, for instance, based on the left-right wheel differences Δσ1 and Δσ2. Specifically, the determination unit 123 can compare the left-right wheel difference Δσ1 with a preset threshold Th1, and can determine that the fixing mechanism for the left front wheel FL or the right front wheel FR is loose if the left-right wheel difference Δσ1 is greater than the threshold Th1 (>0), and that neither of the fixing mechanisms for the left front wheel FL and the right front wheel FR is loose if the left-right wheel difference Δσ1 is smaller than or equal to the threshold Th1. Similarly, the determination unit 123 can compare the left-right wheel difference Δσ2 with a preset threshold Th2 (>0), and can determine that the fixing mechanism for the left rear wheel RL or the right rear wheel RR is loose if the left-right wheel difference Δσ2 is greater than the threshold Th2, and that neither of the fixing mechanisms for the left rear wheel RL and the right rear wheel RR is loose if the left-right wheel difference Δσ2 is smaller than or equal to the threshold Th2. The thresholds Th1 and Th2 may, for example, be previously set based on experimental data obtained under conditions that none of the fixing mechanisms of the vehicle 1 is loose, and under conditions that any of the fixing mechanisms is deliberately caused to come loose. The thresholds Th1 and Th2 may be the same or different.

If in step S5 it is determined that the fixing mechanism for the left front wheel FL or the right front wheel FR is loose or that the fixing mechanism for the left rear wheel RL or the right rear wheel RR is loose (YES), step S6 may be executed. On the other hand, if in step S5 it is determined that none of the fixing mechanisms is loose (NO), step S1 may be executed again.

In step S6, the warning generation unit 124 can generate a warning that there is a sign that a wheel is about to come off, and can output the warning to the warning display device 3. The warning may be represented by text information, an icon, or a graphic or a combination thereof that notifies the driver that there is a loose fixing mechanism. The warning may also include text information, an icon, or a graphic or combination thereof that indicates the axle on which the loose fixing mechanism is inferred to be loose, or text information, an icon, or a graphic or combination thereof that prompts a checking of a fixing mechanism.

### 4. Features

(1) In the determination device 2 according to the above embodiment, the influences of a road surface on which the vehicle 1 is traveling on the acceleration α can be cancelled out between the wheels attached to the same axle. Therefore, it can be appropriately determined whether or not there is a sign that a wheel is about to come off, without separately checking a road surface on which the vehicle 1 is traveling. In addition, instead of the accelerations a themselves of each wheel, the standard deviation σ of the accelerations α extracted in a fixed time window can be calculated, whereby the influence of irregular data can be reduced. As a result, the possibility that a wheel condition is erroneously determined and thus a warning is erroneously output, can be reduced.

(2) In the determination device 2 according to the above embodiment, the smoothing process can be executed before the standard deviations σ of the wheels attached to the same axle are compared. As a result, even when changes in the accelerations α are not exactly synchronous between the wheels, the influences from the road surface can be cancelled.

### 5. Modifications

Although embodiments of the present disclosure have been described above, one or more embodiments of the present disclosure are not limited to that embodiment. Various changes and modifications can be made thereto without departing from the spirit and scope of the present disclosure. For example, changes and modifications described below can be made. In addition, the features of the following variations may be combined as appropriate.

(1) The vehicle 1 is not limited to a four-wheel vehicle. The vehicle 1 may include more axles and more wheels. In addition, the above wheel condition determination method may be applied to only either the front axle 4a or the rear axle 4b.

(2) Step S3 may be omitted. Specifically, the standard deviations σ of the wheels attached to the same axle that are calculated at the same time may be compared with each other, instead of calculating the moving averages of the standard deviations σ. In addition, for example, the determination of step S5 may be carried out for a plurality of left-right wheel differences Δσ1 and a plurality of left-right wheel differences Δσ2 that are continual in time series, and the result of the determination of step S5 may be positive (“YES”) if the number of left-right wheel differences Δσ1 exceeding the threshold Th1 is greater than or equal to a predetermined value or if the number of left-right wheel differences Δσ2 exceeding the threshold Th2 is greater than or equal to a predetermined value.

(3) The acceleration sensors 6 may be attached to the front axle 4a and the rear axle 4b instead of the wheels. In addition, the acceleration sensors 6 may wirelessly perform data communication with the determination device 2.

(4) The representation of variations in the time direction among the accelerations a is not limited to the standard deviation σ, and may be other statistical indexes representing variations in data such as a variance. In addition, the index for comparing variations in the accelerations α of the wheels is not limited to the left-right wheel difference Δσ1 and the left-right wheel difference Δσ2, and may, for example, be the ratio of variations of the left and right wheels.

One or more embodiments of the present disclosure may may be regarded as comprising or consisting of calculating the front-rear and left-right frequency characteristic ratios from wheel speed information, and then calculating the front-rear and left-right load ratios using specification information determined according to the tire type. Additionally or alternatively, one or more embodiments of the present disclosure can compare the acceleration variations of the left and right wheels, which can reduce (including eliminate) the influence of road conditions, thereby enabling detection of looseness in the wheel fixing.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory (ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosed subject matter can also be as set forth according to the following parentheticals.

(1) A wheel condition determination device comprising: circuitry configured to sequentially obtain accelerations in an axle direction of each of wheels attached to both ends of an axle of a vehicle; calculate, based on the sequentially obtained accelerations, variations in a time direction among the accelerations of each of the wheels; calculate an index for comparing the variations of the wheels; and determine whether or not one or a plurality of fixers to fix the wheels to the axle are loose, based on the index.
(2) The wheel condition determination device according to (1) wherein the circuitry is configured to calculate an index for comparing the variations of the wheels after the variations are subjected to a smoothing process for each of the wheels.
(3) The wheel condition determination device according to (1) or (2), further comprising: a warning generator configured to generate and output a warning in response to the circuitry determining that the fixing mechanism is loose.
(4) The wheel condition determination device according to any one of (1) to (3), further comprising: a warning generator configured to generate and output a warning in response to the circuitry determining that the fixing mechanism is loose.
(5) The wheel condition determination device according to according to any one of (1) to (4), wherein each of the one or more fixers includes a bolt and nut fastenable to the bolt.
(6) The wheel condition determination device according to according to any one of (1) to (5), wherein the circuitry continuously sequentially determines, in real time, according to a predetermined cycle, whether or not one or a plurality of fixers to fix the wheels to the axle are loose, based on the index.

(7) A wheel condition determination method that is executed by one or more computers, the wheel condition determination method comprising: sequentially obtaining accelerations in an axle direction of each of wheels attached to both ends of an axle of a vehicle; calculating, based on the sequentially obtained accelerations, variations in a time direction among the accelerations of each of the wheels; calculating an index for comparing the variations of the wheels; and determining whether or not each of a plurality of fasteners to fix the wheels to the axle is loose, based on the index.

(8) The wheel condition determination method according to according to (7), wherein said calculating the index for comparing the variations of the wheels is performed after the variations are subjected to a smoothing process for each of the wheels.
(9) The wheel condition determination method according to according to (7) or (8), further comprising: outputting a warning in response to said determining that the fastener is loose.

(10) The wheel condition determination method according to any one of (7) to (9), further comprising: outputting a warning based on said determining that the fixing mechanism is loose.

(11) The wheel condition determination method according to any one of (7) to (10), wherein each of the fasteners includes a bolt and nut fastenable to the bolt. (12)
(12) The wheel condition determination method according to any one of (7) to (11), wherein said determining is performed continuously and sequentially according to a predetermined cycle.
(13) A non-transitory computer-readable storage medium having stored thereon instructions that, when executed by one or more processors, causes the one or more processors to perform a method for wheel condition determination comprising: sequentially obtaining accelerations in an axle direction of each of wheels attached to both ends of an axle of a vehicle; calculating, based on the sequentially obtained accelerations, variations in a time direction among the accelerations of each of the wheels; calculating an index for comparing the variations of the wheels; and determining whether or not one or more fixers to fix the wheels to the axle are loose, based on the index.
(14) The non-transitory computer-readable storage medium according to (13), wherein said calculating the index for comparing the variations of the wheels is performed after the variations are subjected to a smoothing process for each of the wheels.
(15) The non-transitory computer-readable storage medium according to (13) or (14), further comprising: outputting a warning in response to said determining that the fastener is loose.
(16) The non-transitory computer-readable storage medium according to any one of (13) to (15), further comprising: outputting a warning based on said determining that the fixing mechanism is loose.
(17) The non-transitory computer-readable storage medium according to any one of (13) to (16), wherein each of the fasteners includes a bolt and nut fastenable to the bolt.
(18) The non-transitory computer-readable storage medium according to any one of (13) to (17), wherein said determining is performed continuously and sequentially according to a predetermined cycle.

What is claimed is:

1. A wheel condition determination device comprising:
circuitry configured to
sequentially obtain accelerations in an axle direction of each of wheels attached to both ends of an axle of a vehicle;
calculate, based on the sequentially obtained accelerations, variations in a time direction among the accelerations of each of the wheels;
calculate an index for comparing the variations of the wheels; and
determine whether or not one or a plurality of fixers to fix the wheels to the axle are loose, based on the index.

2. The wheel condition determination device according to claim 1, wherein
the circuitry is configured to calculate an index for comparing the variations of the wheels after the variations are subjected to a smoothing process for each of the wheels.

3. The wheel condition determination device according to claim 1, further comprising: a warning generator configured to generate and output a warning in response to the circuitry determining that the fixing mechanism is loose.

4. The wheel condition determination device according to claim 2, further comprising:
a warning generator configured to generate and output a warning in response to the circuitry determining that the fixing mechanism is loose.

5. The wheel condition determination device according to claim 1, wherein
each of the one or more fixers includes a bolt and nut fastenable to the bolt.

6. The wheel condition determination device according to claim 1, wherein
the circuitry continuously sequentially determines, in real time, according to a predetermined cycle, whether or not one or a plurality of fixers to fix the wheels to the axle are loose, based on the index.

7. A wheel condition determination method that is executed by one or more computers, the wheel condition determination method comprising:
sequentially obtaining accelerations in an axle direction of each of wheels attached to both ends of an axle of a vehicle;
calculating, based on the sequentially obtained accelerations, variations in a time direction among the accelerations of each of the wheels;
calculating an index for comparing the variations of the wheels; and
determining whether or not each of a plurality of fasteners to fix the wheels to the axle is loose, based on the index.

8. The wheel condition determination method according to claim 7, wherein
said calculating the index for comparing the variations of the wheels is performed after the variations are subjected to a smoothing process for each of the wheels.

9. The wheel condition determination method according to claim 7, further comprising:
outputting a warning in response to said determining that the fastener is loose.

10. The wheel condition determination method according to claim 8, further comprising:
outputting a warning based on said determining that the fixing mechanism is loose.

11. The wheel condition determination method according to claim 7, wherein each of the fasteners includes a bolt and nut fastenable to the bolt.

12. The wheel condition determination method according to claim 7, wherein said determining is performed continuously and sequentially according to a predetermined cycle.

13. A non-transitory computer-readable storage medium having stored thereon instructions that, when executed by one or more processors, causes the one or more processors to perform a method for wheel condition determination comprising: :
sequentially obtaining accelerations in an axle direction of each of wheels attached to both ends of an axle of a vehicle;
calculating, based on the sequentially obtained accelerations, variations in a time direction among the accelerations of each of the wheels;
calculating an index for comparing the variations of the wheels; and
determining whether or not one or more fixers to fix the wheels to the axle are loose, based on the index.

14. The non-transitory computer-readable storage medium according to claim 13, wherein
said calculating the index for comparing the variations of the wheels is performed after the variations are subjected to a smoothing process for each of the wheels.

15. The non-transitory computer-readable storage medium according to claim 13, further comprising:
outputting a warning in response to said determining that the fastener is loose.

16. The non-transitory computer-readable storage medium according to claim 14, further comprising:
outputting a warning based on said determining that the fixing mechanism is loose.

17. The non-transitory computer-readable storage medium according to claim 13, wherein each of the fasteners includes a bolt and nut fastenable to the bolt.

18. The non-transitory computer-readable storage medium according to claim 13, wherein said determining is performed continuously and sequentially according to a predetermined cycle.
